(19) United States
(12) Patent Application Publication
(10) Pub. No.: US 2014/0089812 A1
(43) Pub. Date: Mar. 27, 2014

(54) SYSTEM, TERMINAL APPARATUS, AND IMAGE PROCESSING METHOD

(71) Applicant: FUJITSU LIMITED, KAWASAKI-SHI (JP)

(72) Inventors: Kazuki MATSUI, Kawasaki (JP); Kenichi HORIO, Yokohama (JP)

(73) Assignee: FUJITSU LIMITED, KAWASAKI-SHI (JP)

(21) Appl. No.: 13/952,289

(22) Filed: Jul. 26, 2013

(30) Foreign Application Priority Data
Sep. 26, 2012 (JP) 2012-213270

(51) Int. Cl. G06F 17/30

(52) U.S. Cl. CPC G06F 17/30873
USPC 715/738

(57) ABSTRACT

A system includes: an information processing apparatus including a first memory and a first processor coupled to the first memory and configured to: output first information representing a first display area of a first image which is set as a first operation target in accordance with a first operation; and a terminal apparatus including a second memory and a second processor coupled to the second memory and configured to: accept the first operation input by a user, extract first image data of the first image from a second image displayed on a screen of the terminal apparatus, based on the first information, and store the first image data in the second memory.

### CROSS-REFERENCE TO RELATED APPLICATIONS

This application is based upon and claims the benefit of priority of the prior Japanese Patent Application No. 2012-213270, filed on Sep. 26, 2012, the entire contents of which are incorporated herein by reference.

### FIELD

The embodiments discussed herein are related to image processing.

### BACKGROUND

Generally, a thin client system is a system where a client apparatus has minimum functions, and application software and data are managed by a server. Along with a spread of terminal apparatuses such as a tablet terminal and a smartphone, demands for a so-called mobile thin client system where in-company application software and data are securely utilized in a mobile environment are increased. A related art technology includes, for example, a technology of changing a frame rate of screen information that is coded as a moving image generated through application software processing based on operation information from a thin client in a server apparatus. This technology is disclosed, for example, in Japanese Laid-open Patent Publication No. 2011-192229. The related art technology also includes a technology with which a client terminal accumulates and holds document information received from a server in a drawing log buffer, and while a communication with the server is cut off, a document image is reproduced on the basis of the accumulated and held document information to be displayed on a display. This technology is disclosed, for example, in Japanese Laid-open Patent Publication No. 2007-34687.

### SUMMARY

According to an aspect of the invention, a system includes: an information processing apparatus including a first memory and a first processor coupled to the first memory and configured to: output first information representing a first display area of a first image which is set as a first operation target in accordance with a first operation; and a terminal apparatus including a second memory and a second processor coupled to the second memory and configured to: accept the first operation input by a user, extract first image data of the first image from a second image displayed on a screen of the terminal apparatus, based on the first information, and store the first image data in the second memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is an explanatory diagram for describing an example of an image processing method according to an embodiment;

FIG. 2 is an explanatory diagram for describing a system configuration example of a thin client system;

FIG. 3 is a block diagram of a hardware configuration example of a server;

FIG. 4 is a block diagram of a hardware configuration example of a client apparatus;

FIG. 5 is a block diagram of a functional configuration example of the server;

FIG. 6 is a block diagram of a functional configuration example of the client apparatus;

FIG. 7 is an explanatory diagram for describing an operation example of the thin client system (part 1);

FIG. 8 is an explanatory diagram for describing the operation example of the thin client system (part 2);

FIG. 9 is an explanatory diagram for describing an operation example of the client apparatus;

FIG. 10 is a flowchart illustrating an example of a display control processing procedure by the client apparatus;

FIG. 11 is a flowchart illustrating an example of an image processing procedure by the server (part 1); and

FIG. 12 is a flowchart illustrating an example of the image processing procedure by the server (part 2).

### DESCRIPTION OF EMBODIMENT

According to the related art technology, since image data to be displayed on a screen has to be obtained from a server in such a case where a window, an icon, or the like is moved in the screen of the terminal in a thin client system, user operability is problematically decreased.

According to an aspect, among other benefits and advantages, a technology disclosed in a present embodiment aims at avoiding the decrease in the user operability.

Hereinafter, examples of a system, a terminal apparatus, and an image processing method according to respective embodiments will be described in detail with reference to the accompanying drawings.

Example of image processing method is provided herein.

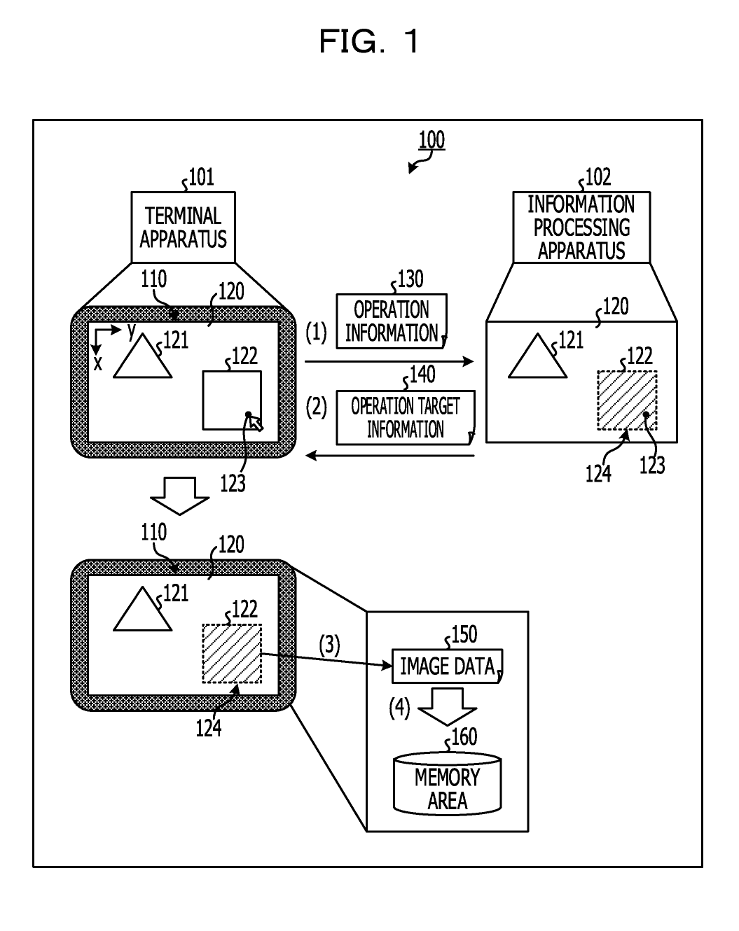

FIG. 1 is an explanatory diagram for describing an example of an image processing method according to an embodiment. In FIG. 1, a system 100 includes a terminal apparatus 101 and an information processing apparatus 102. The system 100 is, for example, a thin client system where the terminal apparatus 101 has minimum functions, and application software and data are managed by the information processing apparatus 102.

The terminal apparatus 101 is a computer that is enabled to communicate with the information processing apparatus 102 via a network, for example. The terminal apparatus 101 includes a screen 110 and has a function of displaying an image on the screen 110 on the basis of image data received from the information processing apparatus 102. The terminal apparatus 101 is a tablet terminal, a laptop personal computer (PC), a smartphone, a mobile phone, or the like.

The information processing apparatus 102 is a computer that can communicate with the terminal apparatus 101 via the network. The information processing apparatus 102 has a function of generating image data of an image to be displayed on the screen 110 of the terminal apparatus 101 and transmitting the image data to the terminal apparatus 101. The information processing apparatus 102 is, for example, a server.

Data such as an image of a window, an icon, or the like is displayed as a result of execution of application software that has been executed in the information processing apparatus 102 in accordance with a request of the terminal apparatus 101. The application software may be electronic mail software, presentation software, spreadsheet software, a design support tool, or the like.

Herein, in a case where the window, the icon, or the like is moved in a screen of the terminal in the thin client system, a display content on the screen is updated, and the image data on the screen is obtained from the server again. Since a communication status with the server tends to be unstable in a case where the thin client system is utilized by the tablet terminal or the like, a response time at the time of the operation of moving the window or the like may be increased, and the user operability may be decreased.

In a case where the window or the like within the screen is moved through a touch operation by a finger, a stylus, or the like, the terminal apparatus does not distinguish between a movement of an entire desk top screen and a movement of the window or the like, and an operation that is not intended by a user may be conducted. It is also conceivable to prepare an operation mode for moving the entire desk top screen and an operation mode for moving the window or the like within the screen, but an operation of switching the operation modes is to be conducted, and also a problem occurs that the user may be confused because of the existence of the plural operation modes.

In view of the above, the information processing apparatus 102 specifies a display area of an image that has been set as an operation target (the window, the icon, or the like) in accordance with the operation input by the user in the terminal apparatus 101 and notifies the terminal apparatus 101 of the display area in the present embodiment. The terminal apparatus 101 provides the image in the display area notified from the information processing apparatus 102. According to this, in a case where the operation input for moving the image corresponding to the operation target is conducted, the renewal can be carried out by utilizing the image held (stored) on the terminal apparatus 101. Hereinafter, an operation example of the system 100 will be described.

(1) The terminal apparatus 101 transmits operation information representing the operation input conducted on the screen 110 to the information processing apparatus 102. The operation herein refers to an input such as a click, double-click, drag and drop, or the like that is conducted on the screen 110. The operation information includes, for example, a type of the operation input conducted on the screen 110 and information representing a location at which the operation input has been conducted.

In the example of FIG. 1, a desktop screen 120 including an object 121 and an object 122 is displayed on the screen 110. As a result of an operation input (click for specifying an operation target) for specifying a point 123 within the desktop screen 120, operation information 130 including a coordinates (x, y) of the point 123 is transmitted from the terminal apparatus 101 to the information processing apparatus 102.

(2) The information processing apparatus 102 transmits operation target information representing a display area of an operation target image that has been set as the operation target in accordance with the operation input specified from the received operation information 130 to the terminal apparatus 101. The operation target image herein is an image selected as a target of movement, deletion, duplication, or the like.

In the example of FIG. 1, the information processing apparatus 102 sets the object 122 including the point 123 within the desktop screen 120 as the operation target and transmits operation target information 140 representing a display area 124 on the screen 110 of the object 122 to the terminal apparatus 101. The operation target information 140 includes, for example, apex data representing coordinates of the respective apexes of the object 122.

(3) The terminal apparatus 101 extracts, from the image data of the screen 110, the image data of the display area 124 specified from the operation target information 140 in a case where the operation target information 140 is received. Specifically, for example, the terminal apparatus 101 specifies the display area 124 at the coordinates of the respective apexes of the object 122 and extracts image data 150 of the display area 124. According to this, it is possible to extract the image data 150 of the object 122 corresponding to the operation target.

(4) The terminal apparatus 101 stores the extracted image data 150 of the display area 124 in a memory area 160 as the image data of the object 122. The memory area 160 is realized, for example, by a volatile memory of the terminal apparatus 101.

As described above, the terminal apparatus 101 can specify the display area 124 of the object 122 that has been set as the operation target in accordance with the operation input by the user to determine the operation target image on the screen 110. The terminal apparatus 101 can also store the image data 150 of the object 122 in the memory area 160 with the system 100.

According to this, the terminal apparatus 101 can renew the display content of the screen 110 by using the image data 150 of the object 122 stored in the memory area 160 in a case where the operation input of moving the object 122 is carried out. That is, the terminal apparatus 101 can renew the display content of the screen 110 without obtaining the image data of the screen 110 by communicating with the information processing apparatus 102.

As a result, for example, in a mobile environment where a communication status is unstable, even in a case where the application software is operated by the terminal apparatus 101, an amount of the data transfer for the renewal, which is generated on all occasions when the window, the icon, or the like is moved, is reduced. Accordingly, it is possible to improve the user operability.

System configuration example of thin client system is provided herein.

Next, a case in which the system 100 illustrated in FIG. 1 is applied to the thin client system will be described.

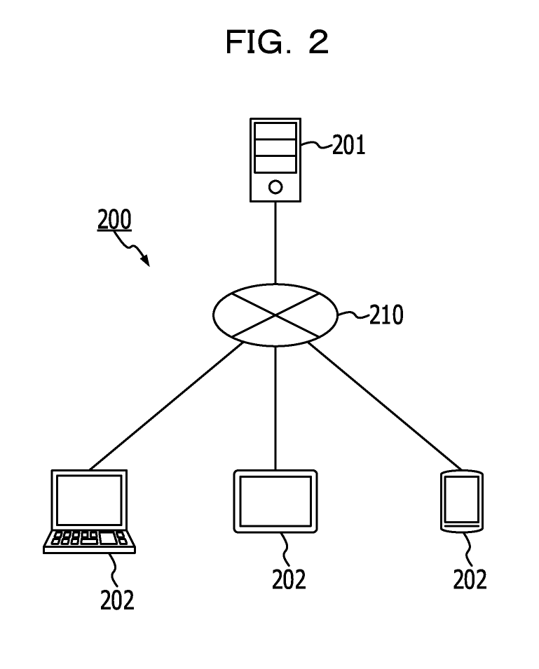

FIG. 2 is an explanatory diagram for describing a system configuration example of the thin client system 200. In FIG. 2, the thin client system 200 includes a server 201 and plural client apparatuses 202 (three client apparatuses in the example of FIG. 2). In the thin client system 200, the server 201 and the client apparatuses 202 are connected to be communicable with each other via a network 210. The network 210 is a mobile communication network (mobile phone network), the internet, or the like.

The thin client system 200 causes the server 201 to remotely control the screen displayed by the client apparatus 202. With the thin client system 200, the processing result executed by the server 201 and the held (stored) data are displayed on the client apparatus 202 as if the client apparatus 202 actually executes the processing and holds the data.

The server 201 is a computer that provides a remote screen control service for remotely controlling the screen displayed on the client apparatus 202. The server 201 is equivalent to the information processing apparatus 102 illustrated in FIG. 1. The client apparatus 202 is a computer that receives the service of the remote screen control service from the server 201. The client apparatus 202 is equivalent to the terminal apparatus 101 illustrated in FIG. 1.

Hardware configuration example of the server 201 is provided herein.

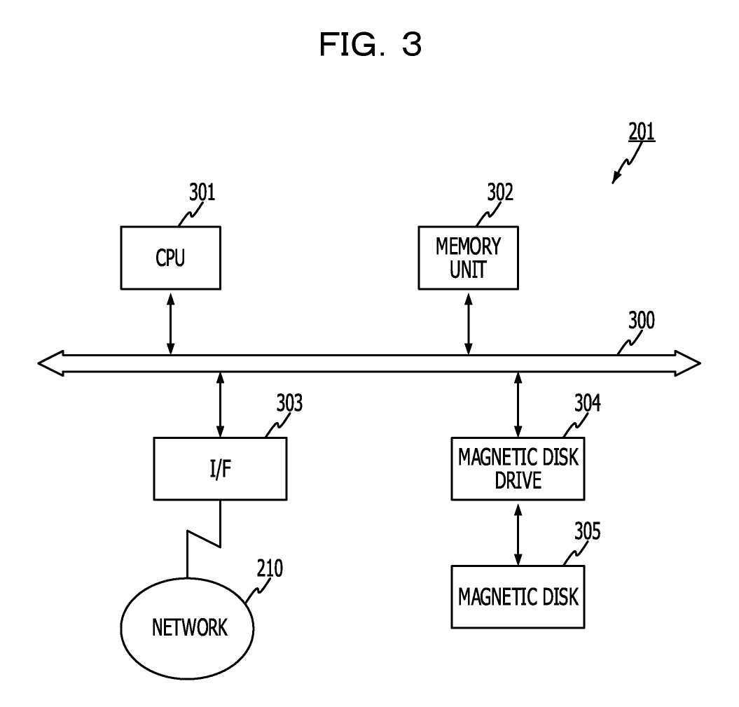

FIG. 3 is a block diagram of a hardware configuration example of the server 201. In FIG. 3, the server 201 includes a central processing unit (CPU) 301, a memory unit 302, an interface (I/F) 303, a magnetic disk drive 304, and a magnetic disk 305. The respective components are mutually connected via a bus 300.

The CPU 301 herein governs the entire control of the server 201. The memory unit 302 includes a read only memory (ROM), a random access memory (RAM), a flash ROM, and the like. Specifically, for example, the flash ROM and the ROM store various programs, and the RAM is used as a work area of the CPU 301. The programs stored in the memory unit 302 are loaded onto the CPU 301, so that coded processing is executed by the CPU 301.

The I/F 303 is connected to the network 210 via a communication circuit and connected to another computer (for example, the client apparatus 202) via the network 210. The I/F 303 governs the network 210 and an internal interface and controls data input and output from the other computer. A modem, a LAN adapter, or the like can be adopted for the I/F 303, for example.

The magnetic disk drive 304 controls read/write of data with respect to the magnetic disk 305 while following the control of the CPU 301. The magnetic disk 305 stores the data written under the control of the magnetic disk drive 304. The server 201 may include a solid state drive (SSD), a key board, a display, or the like in addition to the above-mentioned components.

Hardware configuration example of the client apparatus 202 is provided herein.

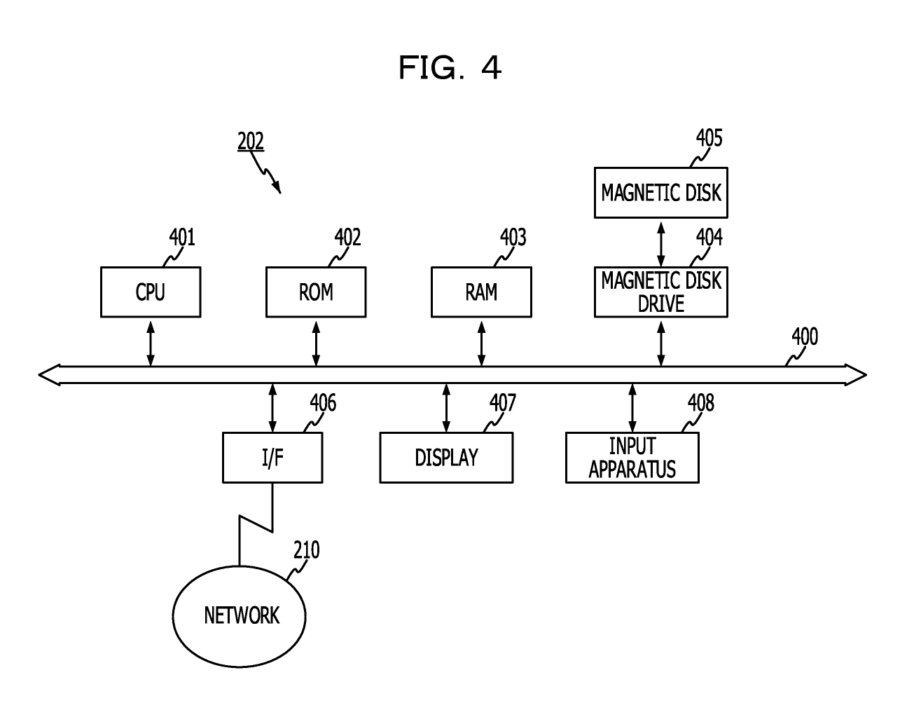

FIG. 4 is a block diagram of a hardware configuration example of the client apparatus 202. In FIG. 4, the client apparatus 202 includes a CPU 401, a ROM 402, a RAM 403, a magnetic disk drive 404, a magnetic disk 405, an I/F 406, a display 407, and an input apparatus 408. The respective components are mutually connected via a bus 400.

The CPU 401 herein governs the entire control of the client apparatus 202. The ROM 402 stores programs such as a boot program. The RAM 403 is used as a work area of the CPU 401. The magnetic disk drive 404 controls read/write of data with respect to the magnetic disk 405 while following the control of the CPU 401. The magnetic disk 405 stores the data written under the control of the magnetic disk drive 404.

The I/F 406 is connected to the network 210 via a communication circuit and connected to another computer (for example, the server 201) via the network 210. The I/F 406 governs the network 210 and an internal interface and controls data input and output from the other computer.

The display 407 displays not only a cursor, an icon, or a tool box but also data such as a document, an image, or information about function. For example, a thin film transistor (TFT) liquid crystal display, a plasma display, or the like can be adopted for the display 407.

The input apparatus 408 conducts input of characters, numbers, various instructions, and the like. The input apparatus 408 may be, for example, a key board with which the data input is conducted or a mouse with which a movement or range selection, a movement or a size change of a window, or the like is conducted. The input apparatus 408 may be a touch panel integrated with the display 407, an input pad or ten key of a touch panel style, or the like.

Functional configuration example of the server 201 is provided herein.

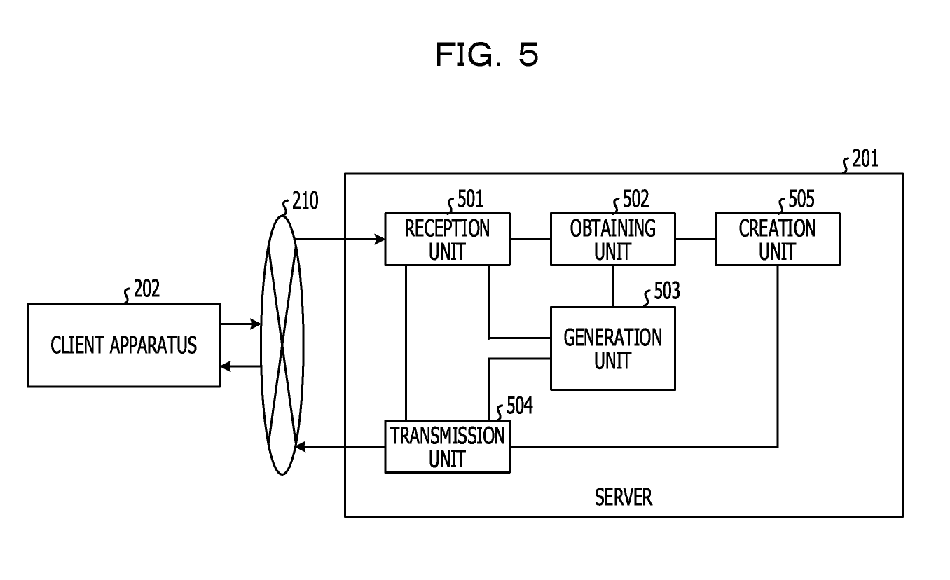

FIG. 5 is a block diagram of a functional configuration example of the server 201. In FIG. 5, the server 201 has a configuration including a reception unit 501, an obtaining unit 502, a generation unit 503, a transmission unit 504, and a creation unit 505. The reception unit 501, the obtaining unit 502, the generation unit 503, the transmission unit 504 and the creation unit 505 have functions serving as a control unit. Specifically, the function is realized while the CPU 301 is caused to execute the program stored in the storage apparatus such as the memory unit 302 or the magnetic disk 305 illustrated in FIG. 3, or the function is realized by the I/F 303. The processing results of the respective function units are stored in the storage apparatus such as the memory unit 302 or the magnetic disk 305.

The reception unit 501 has a function of receiving the operation information from the client apparatus 202. The operation information herein is information representing the operation input by the user by using the input apparatus 408 (see FIG. 4) on a display screen S of the client apparatus 202. The display screen S represents an entire display area of the display 407.

The operation information includes, for example, a type of the operation input such as click, double-click, or drag and drop which is conducted by using the input apparatus 408 and information representing a position of a mouse pointer where the operation input is conducted. The operation information may also include information representing that the operation input has been ended, the number of rotations of a mouse wheel, and information representing a key pressed on the key board or the like.

The obtaining unit 502 has a function of obtaining image data of an image P displayed on the display screen S of the display 407 (FIG. 4) in the client apparatus 202 on the basis of the operation information received by the reception unit 501. Specifically, for example, the obtaining unit 502 notifies the currently executed application software of the operation information in accordance with the request from the client apparatus 202 to obtain the image data of the image P stored in a frame buffer.

The frame buffer is a memory area for temporarily saving the image data for one frame which is displayed on the display screen S and is, for example, a video RAM (VRAM). The frame buffer is realized by a storage apparatus such as the memory unit 302 or the magnetic disk 305.

The generation unit 503 has a function of determining whether or not the display content of the display screen S is updated on the basis of image data of the image P and image data of an image Pₚᵣₑ. The image Pₚᵣₑ herein is an image at a frame preceding the image P displayed on the display screen S by one. Specifically, for example, the generation unit 503 determines that the display content of the display screen S is updated in a case where a difference between the image data of the image P and the image data of the image Pₚᵣₑ exists.

The image data of the image Pₚᵣₑ is stored in an escape buffer. For example, the image data of the image Pₚᵣₑ escapes from the frame buffer to the escape buffer when the image data of the image P is stored in the frame buffer. The escape buffer is realized by a storage apparatus such as the memory unit 302 or the magnetic disk 305.

The generation unit 503 generates image data of a updated area R of the image P in a case where the display content of the display screen S is updated. The updated area R herein is an image representing a updated area in the image P. Specifically, for example, the generation unit 503 generates the image data of the updated area R while a rectangular area including a difference area with the image Pₚᵣₑ in the image P is set as the updated area.

The transmission unit 504 has a function of transmitting the image data of the image P to be displayed on the display screen S to the client apparatus 202. Specifically, for example, the transmission unit 504 compresses (encodes) the image data of the image P to be displayed on the display screen S in a predetermined compression system to transmit the image data of the image P after the compression to the client apparatus 202 as the still image data or the moving image data.

For example, Joint Photographic Experts Group (JPEG), Graphic Interchange Format (GIF), Portable Network Graphics (PNG), and the like are used for the compression system in a case where the image data is a still image. Moving Picture Experts Group (MPEG) is used in a case where the image data is a moving image.

The transmission unit 504 has a function of transmitting the image data of the updated area R generated by the generation unit 503 to the client apparatus 202 in a case where the display content of the display screen S is updated. Specifically, for example, the transmission unit 504 compresses (encodes) the image data of the updated area R to transmit the image data of the updated area R after the compression to the client apparatus 202 as the still image data or the moving image data.

The creation unit 505 has a function of creating the operation target information of the operation target image that has been set as the operation target in accordance with the operation input on the display screen S represented by the operation information that has been received by the reception unit 501. The operation target image herein is, for example, the image that has been set as the operation target in accordance with the operation input on the display screen S.

Specifically, for example, the operation target image is the window or the icon that has been set as the operation target in accordance with the operation input (click) for specifying a certain point on the display screen S. The operation target information is, for example, information representing the display area of the window or the icon corresponding to the operation target on the display screen S.

In the following description, a window W will be described as an example of the operation target image. The window W is a desktop screen, a window included in the desktop screen, or the like that is displayed on the display screen S. The window W that has turned to be active may be denoted as “active window AW”, and the operation target information may be denoted “window information”.

The window information includes, for example, apex data (x, y, h, w) of the active window AW. (x, y) herein represents coordinates of an apex on the upper left of the active window AW on the display screen S. (h) represents a width in a vertical direction of the active window AW on the display screen S. (w) represents a width in a horizontal direction of the active window AW on the display screen S.

Specifically, for example, the creation unit 505 notifies the currently executed application software of the operation information in accordance with the request from the client apparatus 202, so that the active window AW that has turned to be active in accordance with the operation input of specifying the point on the display screen S is specified. The creation unit 505 may also specify the apex data of the specified active window AW to create the window information.

The transmission unit 504 has a function of transmitting the window information created by the creation unit 505 to the client apparatus 202. It is possible to specify the display area of the active window AW that has turned to be active in accordance with the operation input of specifying a certain point on the display screen on the client apparatus 202 with the window information.

In the following description, the display area of the active window AW specified from the window information may be denoted as “active window area AT”.

The creation unit 505 has a function of creating window movement event information in a case where a movement event for moving the active window AW in accordance with the operation input on the display screen S occurs. The window movement event information herein is information representing the active window area AT of the active window AW after the movement on the display screen S. The window movement event information includes, for example, the apex data of the active window AW after the movement (x, y, h, w).

The transmission unit 504 has a function of transmitting the window movement event information created by the creation unit 505 to the client apparatus 202. Specifically, for example, the transmission unit 504 transmits the window movement event information instead of the image data of the updated area R to the client apparatus 202 in a case where the movement event for moving the active window AW occurs.

That is, in a case where the movement event for moving the active window AW occurs, even when the display content of the display screen S is updated on the basis of the movement of the active window AW, the transmission of the image data of the updated area R from the server 201 to the client apparatus 202 may be avoided.

The generation unit 503 may also avoid the generation of the image data of the updated area R in a case where the movement event for moving the active window AW occurs. That is, even when the display content of the display screen S is updated on the basis of the movement of the active window AW, since the transmission of the image data of the updated area R to the client apparatus 202 may be avoided, the generation unit 503 may avoid the generation of the image data of the updated area R.

As a result of the transmission of the window movement event information by the transmission unit 504, the reception unit 501 may receive a non-display image request from the client apparatus 202. The non-display image request herein indicates that image data of a non-display image that is not displayed because of the active window AW in the active window area AT is requested. The non-display image request includes, for example, the apex data of the active window AW (x, y, h, w).

The generation unit 503 may generate the image data of the non-display image that is not displayed because of the active window AW in a case where the non-display image request is received by the reception unit 501. Specifically, for example, the generation unit 503 temporarily sets the active window AW in a non-display status and obtains the image data of the display area specified from the apex data of the active window AW (x, y, h, w) included in the non-display image request from the frame buffer. According to this, it is possible to generate the image data of the non-display image hidden behind the active window AW.

The transmission unit 504 may also transmit the image data of the non-display image to the client apparatus 202 in a case where the generation unit 503 generates the image data of the non-display image that is not displayed because of the active window AW. According to this, the image data of the non-display image hidden behind the active window AW can be transmitted to the client apparatus 202.

Functional configuration example of the client apparatus 202 is provided herein.

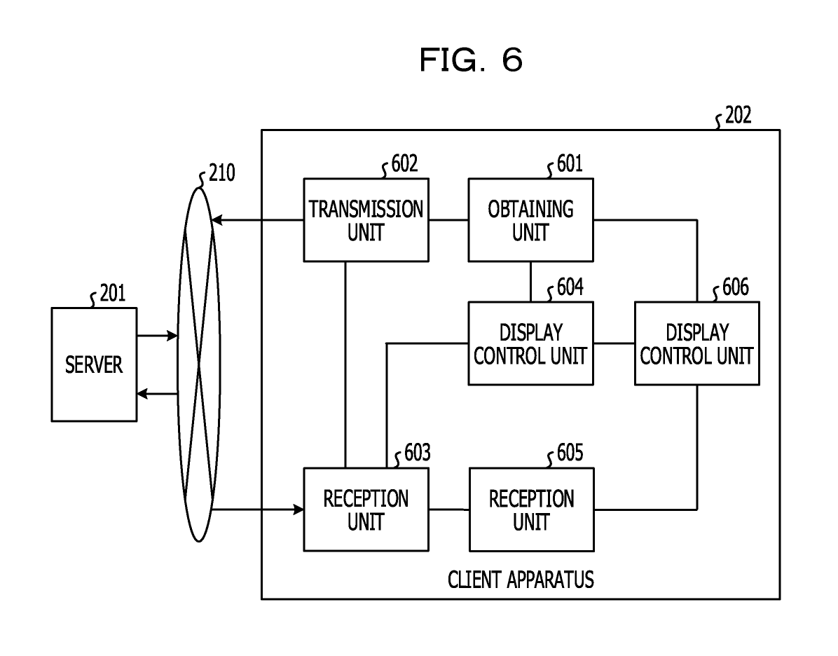

FIG. 6 is a block diagram of a functional configuration example of the client apparatus 202. In FIG. 6, the client apparatus 202 has a configuration including an obtaining unit 601, a transmission unit 602, a reception unit 603, a display control unit 604, an extraction unit 605, and a storage unit 606. The obtaining unit 601, the reception unit 603, the display control unit 604, the extraction unit 605, and the storage unit 606 have functions serving as a control unit. Specifically, for example, the function is realized while the program stored in the storage apparatus such as the ROM 402, the RAM 403, or the magnetic disk 405 illustrated in FIG. 4 is executed by the CPU 401, or the function is realized by the I/F 406. The processing results of the respective function units are stored, for example, in the storage apparatus such as the RAM 403 or the magnetic disk 405.

The obtaining unit 601 has a function of obtaining the operation information representing the operation input by the user. Specifically, for example, the obtaining unit 601 obtains the operation information representing the operation input by the user while the operation input by the user that has used the input apparatus 408 on the display screen S of the display 407 is accepted (see FIG. 4).

As described above, the operation information includes, for example, a type of the operation input by using the input apparatus 408 such as click, double-click, or drag and drop and information representing a position of the mouse pointer where the operation input has been conducted. The operation information may also include information representing that the operation input has been ended, the rotation amount of the mouse wheel, information representing a pressed key on the key board, and the like.

An operation input such as tap, drag, flick, pinch-out, or pinch-in may also be conducted by using the touch panel. In this case, the obtaining unit 601 may obtain operation information obtained by converting the operation input conducted by using the touch panel, for example, into an operation input using a mouse where the application software currently executed in the server 201 can be interpreted.

It is noted that the conversion processing for the operation information may be conducted on the server 201. In addition, the operation input may continuously be conducted as in drag and drop. In this case, the obtaining unit 601 may obtain the operation information representing the operation input by the user at a certain time interval.

The transmission unit 602 has a function of transmitting the operation information obtained by the obtaining unit 601 to the server 201. Specifically, for example, on all occasions when the obtaining unit 601 obtains the operation information, the transmission unit 602 transmits the obtained operation information to the server 201.

The reception unit 603 has a function of receiving the image data of the display screen S from the server 201 as a result of the transmission of the operation information by the transmission unit 602. Specifically, for example, the reception unit 603 receives the image data of the image P of the entire display screen S or the image data of the updated area R of the display screen S from the server 201.

The display control unit 604 has a function of displaying the image data of the display screen S received by the reception unit 603. Specifically, for example, the display control unit 604 controls the display 407 and decodes the received image data of the display screen S to be displayed at the corresponding location on the display screen S.

The reception unit 603 also has a function of receiving the window information of the active window AW that has been set as the operation target in accordance with the operation input on the display screen S from the server 201 as a result of the transmission of the operation information by the transmission unit 602.

The extraction unit 605 has a function of extracting the image data of the active window area AT specified from the window information that has been received by the reception unit 603 from the image data of the display screen S. Specifically, for example, the extraction unit 605 specifies the active window area AT from the apex data included in the window information. The extraction unit 605 then extracts the image data of the specified active window area AT from the image data of the display screen S.

The storage unit 606 has a function of storing the image data of the active window area AT extracted by the extraction unit 605 in a memory area M as the image data of the active window AW. The memory area M is realized, for example, by a cache memory of the CPU 401 or the RAM 403.

As a result of the transmission of the operation information by the transmission unit 602, the reception unit 603 receives the window movement event information from the server 201 in a case where the movement event for moving the active window AW occurs in accordance with the operation input on the display screen S.

The display control unit 604 displays the image data of the active window AW stored in the memory area M in the active window area AT after the movement specified from the window movement event information in a case where the reception unit 603 receives the window movement event information.

According to this, in a case where the movement event of the window W occurs in accordance with the operation input by the user, it is possible to renew the display content of the display screen S without obtaining the image data of the updated area R by communicating with the server 201. The active window area AT before the movement may be set as a blank area.

The transmission unit 602 may transmit the non-display image request to the server 201 in a case where the reception unit 603 receives the window movement event information. In this case, the reception unit 603 receives the image data of the non-display image from the server 201 as a result of the transmission of the non-display image request by the transmission unit 602. As described above, the image data of the non-display image is the image data of the non-display image that is not displayed because of the active window AW in the active window area AT.

The display control unit 604 displays the image data of the non-display image in the active window area AT before the movement in a case where the reception unit 603 receives the image data of the non-display image. The display control unit 604 also displays the image data of the active window AW stored in the memory area M in the active window area AT after the movement specified from the window movement event information.

According to this, in a case where the movement event of the window W occurs, it is possible to renew the display content of the display screen S including the part hidden behind the window W before the movement without obtaining the image data of the updated area R by communicating with the server 201.

The display control unit 604 may also determine whether or not a specified point is within the active window area AT in a case where the operation input for specifying any point on the display screen S is conducted. The active window area AT can be specified, for example, from the window information or the window movement event information. The display control unit 604 may set the entire display screen S (for example, a desktop screen) as the active window AW in a case where the specified point is outside the active window area AT.

As a result of the setting of the entire display screen S as the active window AW, the display control unit 604 may move the entire display screen S in a case where the operation input for moving the active window AW is conducted. According to this, in a case where the movement event of the window W occurs, even when the communication with the server 201 is temporarily cut off, it is possible to renew the display content of the display screen S without receiving the window information from the server 201.

Operation example of the thin client system 200 is provided herein.

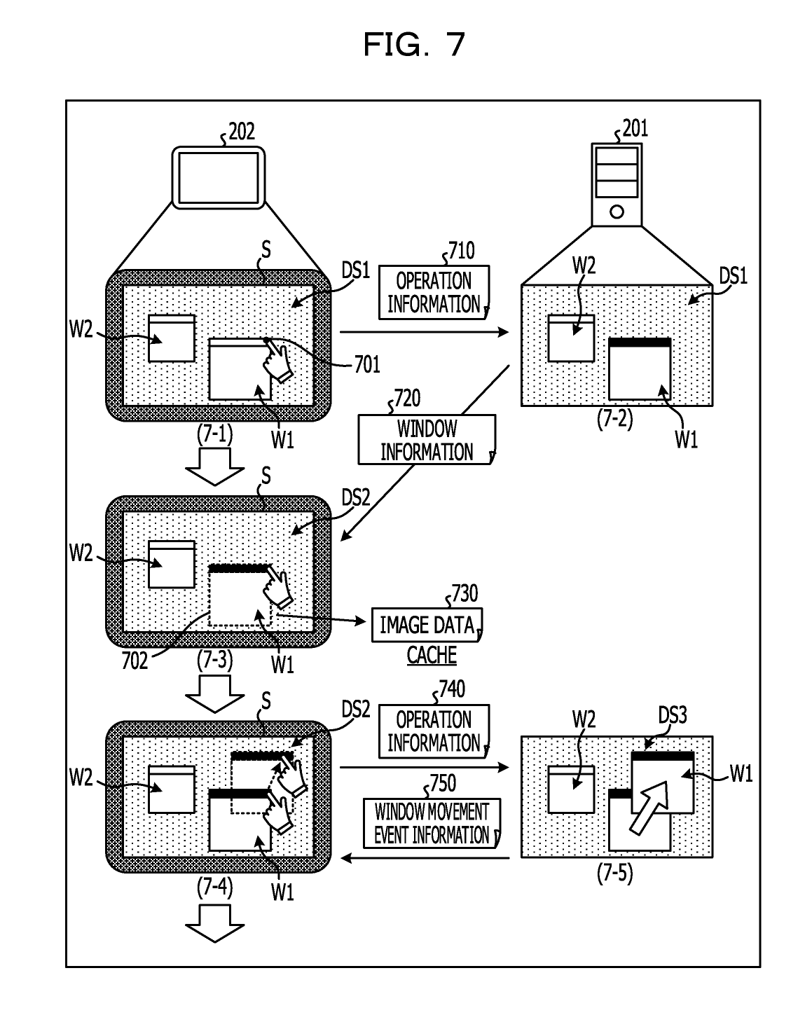

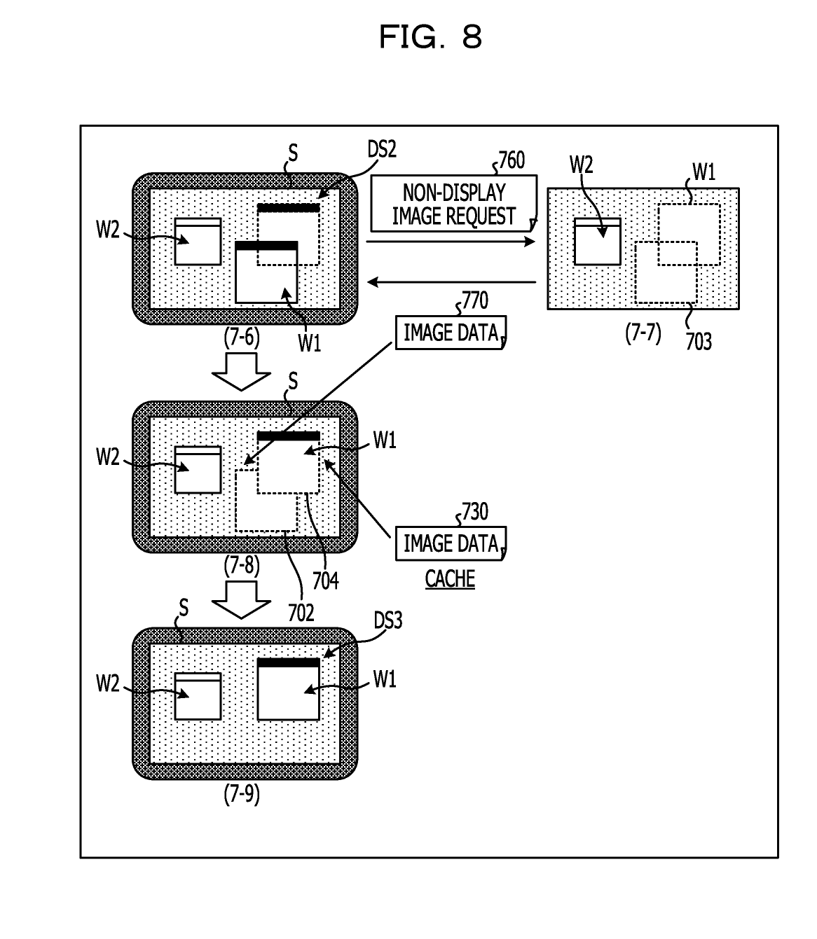

FIG. 7 and FIG. 8 are explanatory diagrams for describing an operation example of the thin client system 200. In FIG. 7, a desktop screen DS1 is displayed on the display screen S of the client apparatus 202. A window W1 and a window W2 are displayed on the desktop screen DS1.

(7-1) The client apparatus 202 transmits operation information 710 to the server 201 in a case where an operation input of touching a point 701 on the display screen S by a finger is conducted. The operation information 710 includes, for example, a type of the operation input “click” conducted at the point 701 and information representing coordinates of the point 701.

(7-2) The server 201 transmits window information 720 of the window W1 that has been set to be active in accordance with the operation input on the display screen S represented by the operation information 710 to the client apparatus 202 in a case where the operation information 710 is received. The window information 720 includes, for example, apex data of the active window W1.

As a result of the operation input of touching the point 701 on the display screen S by a finger, the image data of the updated area R is transmitted from the server 201 to the client apparatus 202, and the display content of the display screen S is updated from the desktop screen DS1 to a desktop screen DS2.

(7-3) The client apparatus 202 specifies a display area 702 of the window W1 from the apex data included in the window information 720 in a case where the window information 720 is received. The client apparatus 202 then extracts image data 730 of the display area 702 from the image data of the display screen S (image data of a bitmap image) to be cached in the memory area M.

(7-4) The client apparatus 202 transmits operation information 740 to the server 201 in a case where the operation input of drag and drop (movement while being touched by a finger) on the display screen S is conducted. The operation information 740 is, for example, an operation information group transmitted at a certain time interval to the server 201 while the operation input of drag and drop is being conducted.

The operation information 740 includes, for example, a type of the operation input “drag and drop” and information representing coordinates of the point where the operation input has been conducted. The operation information 740 may also include information representing that the operation input of drag and drop has been conducted.

(7-5) The server 201 creates window movement event information 750 to be transmitted to the client apparatus 202 in a case where the movement event for moving the window W1 in accordance with the operation input on the display screen S specified from the received operation information 740 occurs. The window movement event information 750 includes the apex data of the window W1 after the movement.

As a result of the occurrence of the movement event for moving the window W1, the display content of the display screen S is updated from the desktop screen DS2 to a desktop screen DS3 on the server 201. Since the image data of the updated area R is not transmitted from the server 201 on the client apparatus 202, the display content of the display screen S is not updated at this time point.

(7-6) The client apparatus 202 transmits non-display image request 760 to the server 201 in a case where the window movement event information 750 is received. The non-display image request 760 includes the apex data (x, y, h, w) of the window W1 before the movement.

(7-7) The server 201 temporarily sets the active window W1 in the non-display status. The server 201 then obtains image data 770 of a display area 703 specified from the apex data of the window W1 before the movement included in the non-display image request 760 to be transmitted to the client apparatus 202.

(7-8) The client apparatus 202 displays the image data 770 of the non-display image on the display area 702 of the window W1 before the movement in a case where the image data 770 of the non-display image is received. The client apparatus 202 also displays the image data 730 of the window W1 cached in the memory area M on a display area 704 of the window W1 after the movement specified from the window movement event information 750.

As a result, the desktop screen DS3 in which the window W1 on the desktop screen DS2 is moved from the display area 702 to the display area 704 is displayed on the display screen S of the client apparatus 202 (see (7-9) in FIG. 8).

In this manner, the client apparatus 202 can renew the display content of the display screen S without obtaining the image data of the updated area R by communicating the server 201 in a case where the movement event of the window W1 in accordance with the operation input by the user occurs.

Operation example of the client apparatus 202 is provided herein.

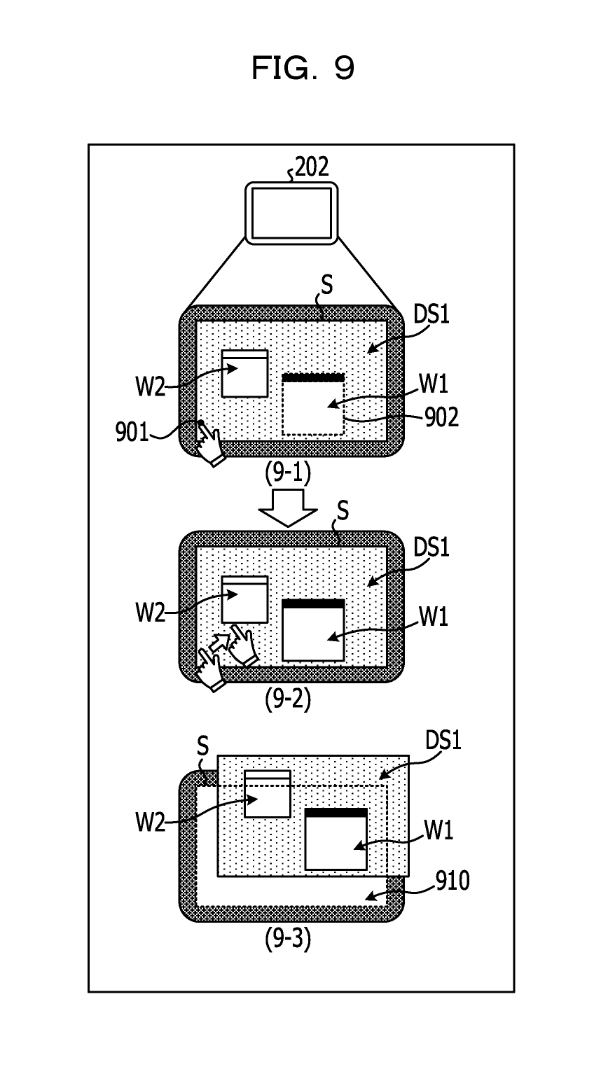

FIG. 9 is an explanatory diagram for describing an operation example of the client apparatus 202. In FIG. 9, the desktop screen DS1 is displayed on the display screen S of the client apparatus 202. The window W1 and the window W2 are also displayed on the desktop screen DS1. The window W1 is an active window specified from the window information from the server 201.

(9-1) The client apparatus 202 determines whether or not the point 901 exists within a display area 902 of the window W1 specified from the window information from the server 201 in a case where an operation input of touching a point 901 on the display screen S by a finger is conducted.

In the example of FIG. 9, it is determined that the point 901 does not exist in the display area 902 since the point 901 is outside the display area 902. According to this, the client apparatus 202 can recognize that a part other than the active window AW is touched by a finger on the display screen S.

(9-2) The client apparatus 202 sets the entire display screen S as the operation target in a case where the point 901 is outside the display area 902 and also the operation input of drag and drop (movement while being touched by a finger) from the point 901 on the display screen S is conducted. In the example of FIG. 9, the desktop screen DS1 is set as the operation target.

(9-3) The client apparatus 202 displays an image 910 (dotted line frame) on the display screen S by moving the desktop screen DS1 corresponding to the operation target in accordance with the operation input of drag and drop (movement while being touched by a finger) conducted on the display screen S.

In this manner, since it is possible to determine the display area 902 of the active window W1, the client apparatus 202 can recognize that a part other than the active window AW on the display screen S is touched by a finger. The client apparatus 202 also can set the entire display screen S as the operation target in a case where the part other than the active window AW is touched by a finger and can move the image of the entire display screen S in accordance with the movement of the touch operation conducted on the display screen S.

Display control processing procedure by the client apparatus 202 is provided herein.

Next, a display control processing procedure by the client apparatus 202 will be described.

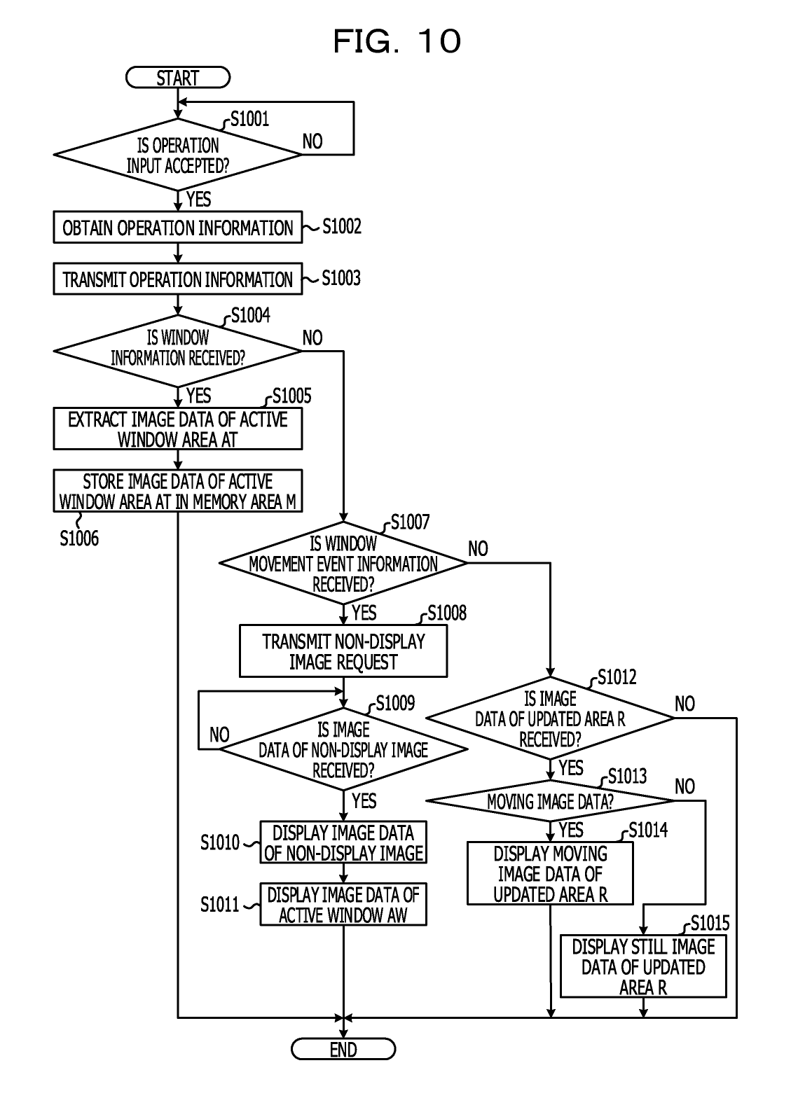

FIG. 10 is a flowchart illustrating an example of the display control processing procedure by the client apparatus 202. In the flowchart of FIG. 10, the client apparatus 202 first determines whether or not an operation input by the user is accepted (step S1001). The client apparatus 202 here stands by for an acceptance of the operation input by the user (step S1001: No).

In a case where the operation input by the user is accepted (step S1001: Yes), the client apparatus 202 then obtains the operation information representing the operation input by the user (step S1002). Next, the client apparatus 202 transmits the obtained operation information to the server 201 (step S1003).

The client apparatus 202 then determines whether or not the window information is received from the server 201 (step S1004). In a case where the window information is received from the server 201 (step S1004: Yes), the client apparatus 202 extracts the image data of the active window area AT specified from the received window information from the image data of the bitmap image currently displayed on the display screen S (step S1005).

The client apparatus 202 then stores the extracted image data of the active window area AT in the memory area M (step S1006), and the series of processing in the present flowchart is ended.

On the other hand, in step S1004, in a case where the window information is not received (step S1004: No), the client apparatus 202 determines whether or not the window movement event information is received from the server 201 (step S1007).

In a case where the window movement event information is received (step S1007: Yes), the client apparatus 202 transmits the non-display image request to the server 201 (step S1008). The client apparatus 202 then determines whether or not the image data of the non-display image is received from the server 201 (step S1009).

The client apparatus 202 stands by for a reception of the image data of the non-display image (step S1009: No). In a case where the image data of the non-display image is received (step S1009: Yes), the client apparatus 202 then displays the image data of the non-display image in the active window area AT before the movement (step S1010).

Next, the client apparatus 202 displays the image data of the active window AW stored in the memory area M in the active window area AT after the movement specified from the window movement event information (step S1011), and the series of processing in the present flowchart is ended.

On the other hand, in step S1007, in a case where the window movement event information is not received (step S1007: No), the client apparatus 202 determines whether or not the image data of the updated area R is received from the server 201 (step S1012).

In a case where the image data of the updated area R is not received (step S1012: No), the client apparatus 202 ends the series of processing in the present flowchart. On the other hand, in a case where the image data of the updated area R is received (step S1012: Yes), the client apparatus 202 determines whether or not the image data of the updated area R is the moving image data (step S1013).

In a case where the image data of the updated area R is the moving image data (step S1013: Yes), the client apparatus 202 displays the moving image data obtained by decoding the image data of the updated area R by using a reconstruction system for the moving image on the display screen S (step S1014), and the series of processing in the present flowchart is ended.

On the other hand, in a case where the image data of the updated area R is the still image data (step S1013: No), the client apparatus 202 displays the still image data obtained by decoding the image data of the updated area R by using a reconstruction system for the still image on the display screen S (step S1015), and the series of processing in the present flowchart is ended.

In a case where the window information received in step S1004 includes the image data of the updated area R, the client apparatus 202 displays the moving image data or the still image data of the updated area R on the display screen S.

According to this, the client apparatus 202 can renew the display content of the display screen S without obtaining the image data of the updated area R by communicating the server 201 in a case where the movement event of the window W occurs in accordance with the operation input by the user.

Image processing procedure of the server 201 is provided herein.

Next, an image processing procedure of the server 201 will be described.

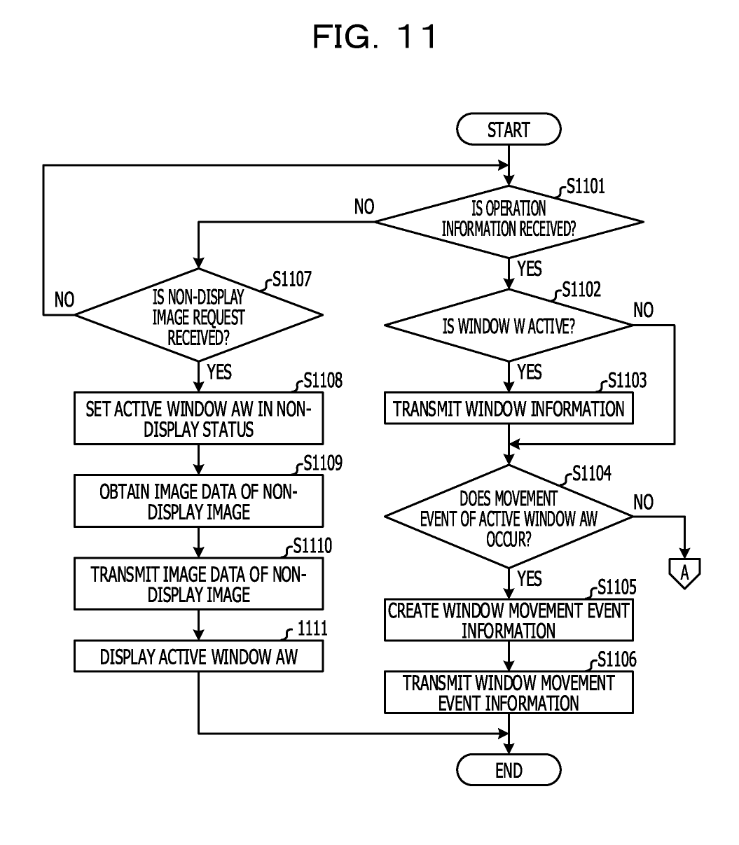

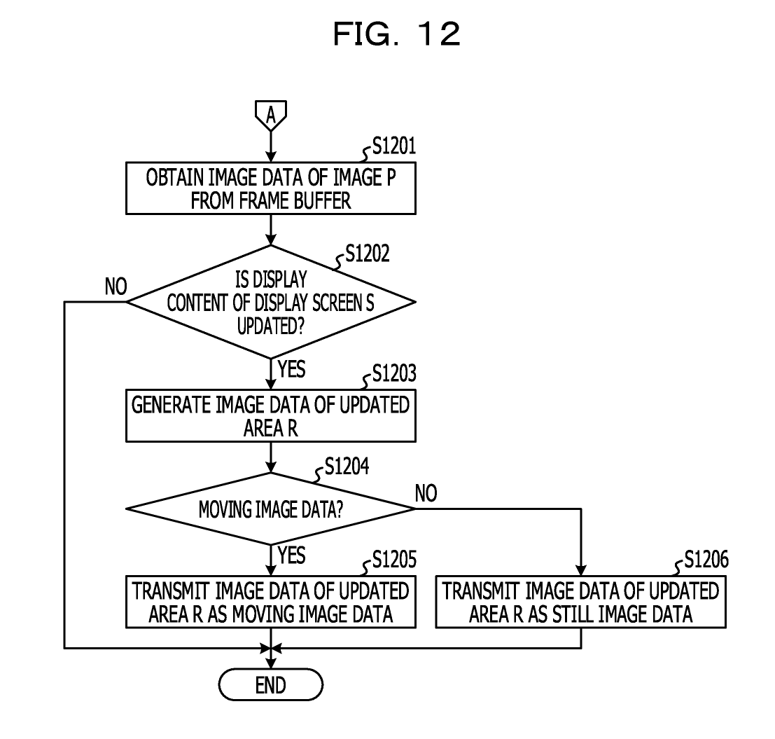

FIG. 11 and FIG. 12 are flowcharts illustrating an example of an image processing procedure by the server 201. In the flowchart of FIG. 11, the server 201 first determines whether or not the operation information is received from the client apparatus 202 (step S1101).

In a case where the operation information is received from the client apparatus 202 (step S1101: Yes), the server 201 determines whether or not the window W in the display screen S becomes active in accordance with the operation input represented by the received operation information (step S1102).

In a case where the window W is not active (step S1102: No), the server 201 shifts to step S1104. On the other hand, in a case where the window W becomes active (step S1102: Yes), the server 201 transmits the window information of the window W to the client apparatus 202 (step S1103).

The server 201 then determines whether or not the movement event for the active window AW occurs (step S1104). In a case where the movement event for the active window AW occurs (step S1104: Yes), the server 201 creates the window movement event information (step S1105). The server 201 then transmits the created window movement event information to the client apparatus 202 (step S1106), and the series of processing in the present flowchart is ended.

In step S1101, in a case where the operation information is not received (step S1101: No), the server 201 determines whether or not the non-display image request is received from the client apparatus 202 (step S1107). In a case where the non-display image request is not received (step S1107: No), the server 201 returns to step S1101.

On the other hand, in a case where the non-display image request is received (step S1107: Yes), the active window AW is set in the non-display status on the display screen S (step S1108). The server 201 then obtains the image data of the non-display image specified from the non-display image request from the frame buffer (step S1109).

Next, the server 201 transmits the obtained image data of the non-display image to the client apparatus 202 (step S1110). The server 201 then displays the active window AW that has been set in the non-display status (step S1111), and the series of processing in the present flowchart is ended.

In step S1104, in a case where the movement event for the active window AW does not occur (step S1104: No), the server 201 shifts to step S1201 illustrated in FIG. 12.

In the flowchart of FIG. 12, the server 201 first obtains the image data of the image P from the frame buffer (step S1201). Next, the server 201 determines whether or not the display content of the display screen S is updated on the basis of the image data of the image P and the image data of the image Pₚᵣₑ (Step S1202).

In a case where the display content of the display screen S is not updated (step S1202: No), the server 201 ends the series of processing in the present flowchart.

On the other hand, in a case where the display content of the display screen S is updated (step S1202: Yes), the server 201 generates the image data of the updated area R (step S1203). The server 201 then determines whether or not the generated image data of the updated area R is the moving image data (step S1204).

In a case where the image data of the updated area R is the moving image data (step S1204: Yes), the server 201 compresses the image data of the updated area R in a predetermined compression system and transmits the compressed image data to the client apparatus 202 as the moving image data (step S1205), so that the series of processing in the present flowchart is ended.

On the other hand, in a case where the image data of the updated area R is the still image data (step S1204: No), the server 201 compresses the image data of the updated area R in a predetermined compression system and transmits the compressed image data to the client apparatus 202 as the still image data (step S1206), so that the series of processing in the present flowchart is ended.

According to this, it is possible to transmit the window information of the window W that has turned to be active in accordance with the operation input on the display screen S of the client apparatus 202 to the client apparatus 202. It is also possible to transmit the window movement event information to the client apparatus 202 in accordance with the operation input on the display screen S in a case where the movement event for moving the active window AW occurs.

In step S1111 illustrated in FIG. 11, the processing of displaying the active window AW that has been set in the non-display status may be executed, for example, in a case where the operation input of moving the active window AW is ended.

In step S1204, for example, the server 201 may determine whether or not the image data of the updated area R is the moving image data on the basis of identification information added to the image data of the image P for identifying whether the image P is still image data or moving image data.

The server 201 may have a function of compressing data at a part where a motion is large between frames into data in a compression system for the moving image to be transmitted to the client apparatus 202. Specifically, for example, the server 201 divides an image obtained by notifying the application software of the operation information into plural areas and monitors a frequency of changes for each of the divided areas. The server 201 may deal with an area where the frequency of changes exceeds a threshold as a moving image area.

In this case, in step S1204, for example, the server 201 may determine whether or not the image data of the updated area R is the moving image data depending on whether or not the updated area R includes the moving image area. More specifically, for example, in a case where the updated area R includes the moving image area, the server 201 determines that the image data of the updated area R is the moving image data. For a technology of compressing the data at the part where the motion is large between the frames into the data in the compression system for the moving image to be transmitted to the client apparatus 202, for example, see Japanese Laid-open Patent Publication No. 2011-238014.

As described above, the server 201 can transmit the window information of the window W that has turned to be active in accordance with the operation input on the display screen S of the client apparatus 202 to the client apparatus 202 with the thin client system 200 in the embodiment. The client apparatus 202 can also extract the image data of the active window area AT specified from the window information from the image data of the display screen S in a case where the window information is received. The client apparatus 202 can store the extracted image data of the active window area AT in the memory area M as the image data of the active window AW.

According to this, the client apparatus 202 can specify the display area of the window W that has been set to be active in accordance with the operation input by the user and distinguish the operation target image and also cache the image data of the window W.

The server 201 can transmit the window movement event information to the client apparatus 202 in accordance with the operation input on the display screen S in a case where the movement event for moving the active window AW occurs. The client apparatus 202 can display the image data of the active window AW stored in the memory area M in the active window area AT specified from the window movement event information in a case where the window movement event information is received.

According to this, the client apparatus 202 can renew the display content of the display screen S without obtaining the image data of the updated area R by communicating with the server 201 in a case where the movement event of the window W occurs in accordance with the operation input by the user. For example, even in a case where the application software is operated by the user by using the client apparatus 202 in a mobile environment where a communication status is unstable, the data transfer amount for the renewal generated each time the window W is moved is reduced, and it is possible to improve the user operability.

The client apparatus 202 can also transmit the non-display image request of the non-display image that has been set in the non-display status because of the window W to the server 201 in a case where the window movement event information is received. The server 201 can also transmit the image data of the non-display image that has been set in the non-display status because of the window W to the client apparatus 202 in a case where the non-display image request is received.

According to this, the client apparatus 202 can obtain the image data of the non-display image hidden behind the window W before the movement in a case where the movement event of the window W occurs.

The client apparatus 202 can also display the image data of the non-display image in the active window area AT before the movement in a case where the image data of the non-display image is received. The client apparatus 202 can also display the image data of the active window AW stored in the memory area M in the active window area AT after the movement.

According to this, the client apparatus 202 can renew the display content of the display screen S including the part hidden behind the window W before the movement without obtaining the image data of the updated area R by communicating with the server 201 in a case where the movement event of the window W occurs.

The client apparatus 202 can also determine whether or not the specified point is within the active window area AT on the basis of the window information or the window movement event information in a case where the operation input for specifying any point on the display screen S is accepted. The client apparatus 202 can set the entire image displayed on the display screen S as the operation target in a case where the specified point is outside the active window area AT.

According to this, in a case where the movement event of the window W occurs, even if the communication with the server 201 is temporarily cut off, the display content of the display screen S can be updated, instability of the communication can be covered up and minimized with respect to the user. The user can also smoothly operate the movement of the entire screen and the movement of the window W without confusion in a case where the movement operation of the window W is conducted through a touch operation.

The image processing method and display control method described in the present embodiment mode can be realized while previously prepared programs are executed by a computer such as a personal computer or a work station. The present image processing program and display control program are recorded on a computer-readable recording medium such as a hard disk, a flexible disk, a CD-ROM, an MO, or a DVD and executed by being read out from the recording medium by the computer. The present image processing program and display program may be distributed via a network such as the internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A system comprising:
an information processing apparatus including a first memory and a first processor coupled to the first memory and configured to:
output first information representing a first display area of a first image which is set as a first operation target in accordance with a first operation; and
a terminal apparatus including a second memory and a second processor coupled to the second memory and configured to:
accept the first operation input by a user,
extract first image data of the first image from a second image displayed on a screen of the terminal apparatus, based on the first information, and
store the first image data in the second memory.

2. The system according to claim 1,
wherein the first processor is configured to:
output second information representing a second display area indicating the first image is displayed after a movement when a movement event in accordance with second operation is received from the terminal apparatus, the second operation is accepted after the first operation by the terminal apparatus, and
wherein the second processor is configured to:
receive the second information, and
display the first image in the second display area based on the second information and the first image data stored in the second memory.

3. The system according to claim 2,
wherein the second processor is configured to:
request transmission of a third image of a third display area when the second information is received, the third display area is difference between the first display area and the second display area,
receive the third image, and
display the thirst image in the third display area.

4. The system according to claim 3,
wherein the second processor is configured to:
determine, when third operation specifying a point on the screen is accepted after the first operation, whether the point is within the first display area based on the first information, and
set the second image displayed on the screen as a second operation target when the point is determined to be outside the first display area.

5. The system according to claim 1, wherein the second processor is configured to renew the screen using the first image data in the second memory.

6. The system according to claim 1,
wherein the first processor is further configured to:
generate the second image, and send the second image to the terminal apparatus,
wherein the second processor is further configured to:
display the second image before the first operation is accepted, and send third information indicating a selected point by the first operation to the information processing apparatus, and
wherein the first processor is further configured to:
receive the third information, and
specify the first operation target based on the third information.

7. A terminal apparatus comprising:
a memory; and
a processor coupled to the memory and configured to:
accept a first operation input by a user,
obtain first information representing a first display area of a first image which is set as a first operation target in accordance with the first operation, from an information processing apparatus,
extract first image data of the first image from a second image displayed on a screen, based on the first information, and
store the first image data in the memory.

8. The terminal apparatus according to claim 7, wherein the processor is configured to:
receive a second information representing a second display area indicating the first image is displayed after a movement when a movement event in accordance with second operation, from the information processing apparatus, the second operation is accepted after the first operation, and
display the first image in the second display area based on the second information and the first image data stored in the memory.

9. The terminal apparatus according to claim 8, wherein the second processor is configured to:
request transmission of a third image of a third display area when the second information is received, the third display area is difference between the first display area and the second display area,
receive the third image, and
display the thirst image in the third display area.

10. The terminal apparatus according to claim 9, wherein the processor is configured to:
determine, when third operation specifying a point on the screen is accepted after the first operation, whether the point is within the first display area based on the first information, and
set the second image displayed on the screen as a second operation target when the point is determined to be outside the first display area.

11. The terminal apparatus according to claim 7, wherein the processor is configured to renew the screen using the first image data in the memory.

12. An image processing method executed by a computer, the image processing method comprising:
accepting a first operation input by a user;
obtaining first information representing a first display area of a first image which is set as a first operation target in accordance with the first operation, from an information processing apparatus;
extracting first image data of the first image from a second image displayed on a screen, based on the first information, by a processor; and
storing the first image data in a memory.

13. The image processing method according to claim 12, further comprising:
receiving a second information representing a second display area indicating the first image is displayed after a movement when a movement event in accordance with second operation, from the information processing apparatus, the second operation is accepted after the first operation; and
displaying the first image in the second display area based on the second information and the first image data stored in the memory.

14. The image processing method according to claim 13, further comprising:
requesting transmission of a third image of a third display area when the second information is received, the third display area is difference between the first display area and the second display area;
receiving the third image; and
displaying the thirst image in the third display area.

15. The image processing method according to claim 14, further comprising:
determining, when third operation specifying a point on the screen is accepted after the first operation, whether the point is within the first display area based on the first information; and
setting the second image displayed on the screen as a second operation target when the point is determined to be outside the first display area.

16. The image processing method according to claim 12, wherein the screen is updated using the first image data in the memory.

17. The image processing method according to claim 12, further comprising:
receiving the second image from the information processing apparatus;
displaying the second image before the first operation is accepted; and
send third information indicating a selected point by the first operation to the information processing apparatus, wherein the selected point is included in the first display area.
